(19) United States
(12) Patent Application Publication
(10) Pub. No.: US 2023/0366511 A1
(43) Pub. Date: Nov. 16, 2023

(54) CRYOGENIC STORAGE SYSTEM

(71) Applicant: MAGNA Energy Storage Systems GesmbH, Sinabelkirchen (AT)

(72) Inventors: Rainer PUCHLEITNER, Graz (AT); Sergiy PUTSELYK, Pinkafeld (AT)

(73) Assignee: MAGNA Energy Storage Systems GesmbH, Sinabelkirchen (AT)

(21) Appl. No.: 18/315,798

(22) Filed: May 11, 2023

(30) Foreign Application Priority Data
May 13, 2022 (DE) 102022204969.1

(51) Int. Cl. F17C 1/12; F17C 5/00

(52) U.S. Cl. CPC F17C 1/12; F17C 5/007; F17C 2223/0161; F17C 2203/0629; F17C 2205/0332; F17C 2227/0306; F17C 2205/0352; F17C 2221/012; F17C 2203/0391; F17C 2270/0184; F17C 2270/0168

(57) ABSTRACT

A storage system for storing a cryogenic medium. The storage system includes a dual-wall cryogenic tank having an inner storage container for receiving the cryogenic medium and an outer container which surrounds the inner storage container. An evacuated hollow space is arranged between the inner storage container and outer container. A removal line serving as a removal duct forms a fluidic connection from the inner space of the inner storage container to a consumer connection. A first controllable line shut-off valve and a first heat exchanger are arranged in the removal duct. The storage system is operable such that, in the event of a crash, a shutdown of the storage system and escaping of the stored cryogenic medium is prevented. This is achieved via a first heat exchanger arranged within the evacuated hollow space, and a line shut-off valve which is arranged in the removal line. The line shut-off valve is operable, in the event of a fracture of a fluid-carrying connection, to automatically shut off fluid flow of the cryogenic medium.

### CROSS-REFERENCE TO RELATED APPLICATIONS

The present application claims priority under 35 U.S.C. § 119 to German Patent Publication No. DE 102022204969.1 (filed on May 18, 2022), which is hereby incorporated by reference in its complete entirety.

### TECHNICAL FIELD

One or more embodiments relate to a storage system for storing a cryogenic medium, in particular, for storing hydrogen.

### BACKGROUND

It is known that cryogenic media, that is to say, cryogenic and at least partially fluid media, such as hydrogen or helium, can be stored in a storage container in order to transport energy via corresponding removal lines to a consumer.

The storage of gases, in particular hydrogen, in the cryogenic state is with regard to energy density particularly suitable for mobile use, in particular in motor vehicles in order to achieve great ranges.

For the storage of cryogenic media, vacuum-insulated storage containers which comprise a dual-walled container with an inner container and an outer container are generally used. The hollow space between the two containers is evacuated in order to reduce the thermal flow and provided with an insulation layer.

Starting from the storage container, the transport to the consumer is then carried out via removal lines so that a conversion of the stored energy into drive energy can be carried out, for example, via fuel cells and an electric motor. In addition to the problems generally linked with the storage and handling of cryogenic media, other requirements further arise particularly for mobile use.

The operation of motor vehicles with cryogenic storage systems is in principle considered to be very safe since the authorisation procedures are very strict. Known storage systems have a large number of precautions which both during operation of the vehicle and in the event of an accident ensure adequate safety. These safety precautions include, for example, an arrangement of the storage system at a protected installation location, providing the storage system with pressure relief devices and safety fuses which respond to pressure or temperature and the use of safety valves such as pressure reduction valves, which reduce the gas pressure from the storage pressure level to the pressure level of the removal line to the consumer/fuel cell.

This has significant safety advantages if, in the event of an impact, the line is detached from the tank since then only the reduced pressure in the removal line which constitutes the connection from inside the tank to the consumer is present.

Furthermore, it is known for safe operation of cryogenic storage systems to provide a possibility for shutting off the inner tank which is filled with the cryogenic medium to the consumer. Generally, this shutting-off is implemented in the form of a shut-off valve directly on the removal path at the outlet of the inner pressure container.

The disadvantage in this instance, however, is that in the event of an accident of the motor vehicle with an installed cryogenic storage system, pipelines which are arranged outside the dual-walled storage container can become damaged. In this instance, the inner container can leak.

### SUMMARY

Against this background, an object of the present invention is to develop a cryogenic storage system for mobile operation in such a manner that it is configured in such an operationally reliable manner that, in particular, in the event of a crash a shutting-off of the storage system and escape of the stored cryogenic medium are prevented.

This object is achieved with the present invention via a cryogenic storage system that includes a dual-wall cryogenic tank that includes an inner storage container and an outer container which surrounds the inner storage container, the inner container defining an inner space which receives the cryogenic medium; a hollow space defined by the inner storage container and the outer container; a removal line to serve as a removal duct that forms a fluid-carrying connection from the inner space to a consumer connection; a first controllable line shut-off valve fluidically connected to the removal line; a first heat exchanger fluidically connected to the gas removal line; and a pressure build-up system. The pressure build-up system includes a mass flow control valve arranged in the removal line outside of the dual-wall cryogenic tank, an inner container heat exchanger arranged in the hollow space and fluidically connected to the inner storage container via a first flow line, and a second heat exchanger which is fluidically connected to the inner storage container via a second flow line. A controllable line shut-off valve is fluidically connected to the removal line and operable to automatically shut off flow of the cryogenic medium in response to a fracture of a fluid-carrying connection.

As a result of the arrangement in accordance with one or more embodiments, protection in the event of an accident is achieved by a separate separation of the environment and inner container being provided and consequently an escape of the cryogenic medium which is stored in the inner container is prevented.

To this end, in a removal line of a cryogenic storage system, wherein the removal line forms a removal duct, a line shut-off valve which in the event of a fracture of the removal line, for example, in the event of an accident, automatically interrupts the flow, is configured.

Advantageously, the removal line is in the form of a gas removal line, wherein the gas removal line forms a removal duct which supplies the gaseous medium from the storage container to a consumer via a consumer connection. In the gas removal line, a line shut-off valve, which in the event of a fracture of the gas removal line, for example, in the event of an accident, automatically interrupts the flow, is configured.

In one embodiment, the removal line is a gas removal line, another fluid removal line is not provided in the storage system in accordance with one or more embodiments.

In another embodiment, the removal line is provided as a fluid removal line.

In accordance with one or more embodiments, the line shut-off valve is arranged in the evacuated hollow space between the inner container and outer container in front of a first heat exchanger. In this instance, the line shut-off valve must be operated at cryogenic temperatures. Although this arrangement does require a complex insulation of the “safety valve”, it does provide the highest level of safety in the event of an accident.

In accordance with one or more embodiments, the line shut-off valve is arranged in the evacuated hollow space between the inner container and outer container upstream behind the first heat exchanger. The line shut-off valve can be operated under “warm temperatures” so that a complex construction of the valve body can be dispensed with.

In accordance with one or more embodiments, the line shut-off valve is arranged outside the outer container directly in front of the consumer connection.

In accordance with one or more embodiments, the line shut-off valve is arranged outside the container wall of the outer container.

### DRAWINGS

Embodiments will be illustrated by way of example in the drawings and explained in the description hereinbelow:

FIG. 1 illustrates a storage system in accordance with a first embodiment.

FIG. 2 illustrates a storage system in accordance with a second embodiment.

FIG. 3 illustrates a storage system in accordance a third embodiment.

FIG. 4 illustrates a storage system in accordance with a fourth embodiment.

### DESCRIPTION

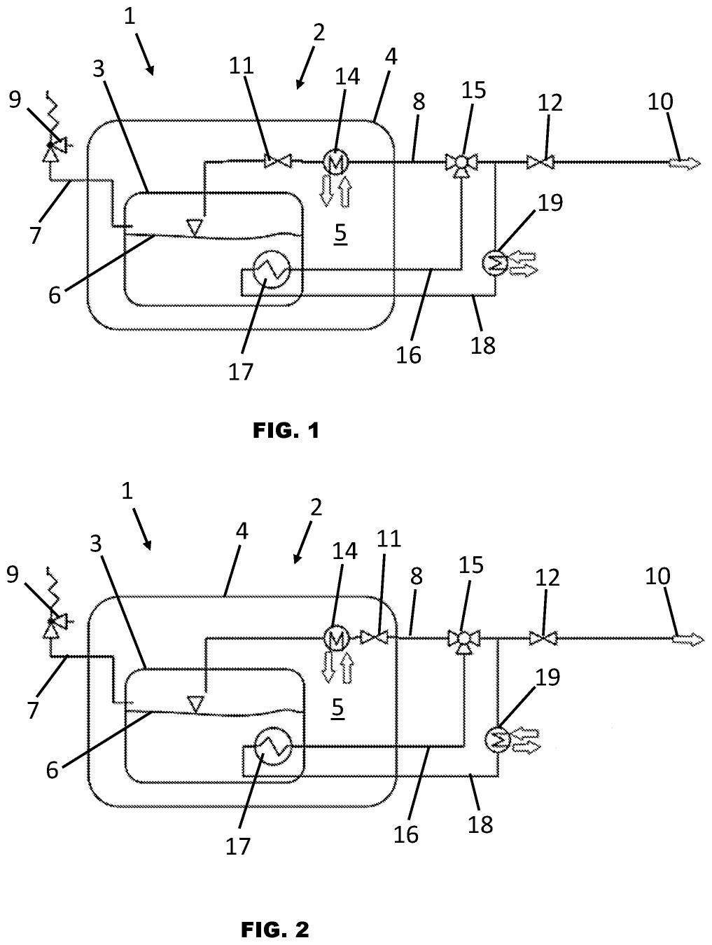

In FIG. 1, a storage system 1 in accordance with one or more embodiments for storing a cryogenic medium, in particular, for storing hydrogen, is illustrated. The following description relates to the use of hydrogen as a cryogenic medium. It is self-evident to a person skilled in the art, however, that other media can also be used.

The storage system 1 comprises a cryogenic tank 2 which is installed for storing liquid hydrogen in a motor vehicle (not illustrated). The cryogenic tank 2 is a dual-walled container and comprises an internal pressure-resistant storage container 3 which is supported in an outer container 4. The storage serves to position the two shells of the dual-walled container and comprises between the outer container 4 and inner container/storage container 3 suspensions which are partially not illustrated. The hollow space 5 between the inner storage container 3 and the outer container 4 is evacuated to reduce the thermal flow and consequently to protect the storage container 3 from additional incident heat and provided with an insulation layer. The hollow space is referred to below as a vacuum chamber.

The outer container 4 is delimited by a container wall which comprises an outer side 4a and an opposing inner side which faces the storage container 3.

The cryogenic medium, in particular hydrogen, is located in the lower region of the storage container 3, that is to say, below the fluid surface 6 which is illustrated in the figures as an undulating line as a fluid in the storage container 3, above the fluid surface 6 in the gaseous state.

A gas removal line 8 is configured to remove the gaseous medium from the storage container 3 so that the free end of the gas removal line 8 terminates above the fluid surface 6, close to the cover of the storage container 3, in the storage container 3.

The gas removal line 8 forms a removal duct which supplies the gaseous medium starting from the storage container to a consumer via a consumer connection 10, in particular, a fuel cell acting as a consumer. As can be seen in the figures, the gas removal line is guided from the inner space of the storage container 3 through the container wall of the storage container 3, the vacuum chamber 5, the container wall of the outer container 4 into the external environment A.

A fluid removal line for removing the fluid medium from the storage container 3 is not configured.

Furthermore, the storage system 1 comprises for legal safety reasons an excess pressure relief line 7, the free end of which also terminates above the fluid surface 6 and is guided outwards from the dual-walled cryogenic tank 2 and contains an excess pressure safety valve 9.

The terms “covers” and “base” relate in this instance to the conventional installation location of the storage container, for example, in a travelling, floating or flying transport apparatus, wherein the gravitational force during normal operation of the transport apparatus acts in the direction towards the base of the storage container.

In the gas removal line 8, starting from the storage container in the direction of the consumer, a first line shut-off valve 11 is first arranged. The first line shut-off valve 11 is located outside the storage container 3 and inside the vacuum chamber 5 of the dual-walled cryogenic tank 2.

The first line shut-off valve 11 is in the form of an automatic safety valve which in the event of a fracture of the gas removal line, for example, in the event of an accident, interrupts the flow.

A second controllable line shut-off valve 12 is arranged outside the outer container 4 in the gas removal line 8 in front of the consumer connection.

The second line shut-off valve can be controlled via a control apparatus. In this instance, the flow can preferably not only be interrupted or released by the line shut-off valve, but also reduced.

In the gas removal line 8, this line 8 is connected in terms of flow after the first line shut-off valve 11 to a first heat exchanger 14 to heat the medium/cryogenic hydrogen which has been removed. The heat exchanger 14 is used to heat the hydrogen from cryogenic temperatures to ambient temperature. The first heat exchanger 14 is also arranged inside the vacuum chamber 5.

As can be seen from the illustration of FIG. 1, a 3/2-way valve is arranged in the gas removal line 8 outside the outer container 4.

The hydrogen which is heated to ambient temperature accordingly flows through the gas removal line 8 which is guided through the outer container through the 3/2-way valve and the second controllable line shut-off valve 12, which is subsequently arranged, to the consumer connection 10.

To increase the pressure or to maintain the pressure in the inner container 3 of the cryogenic tank 2, the storage system 1 comprises a pressure build-up system. This pressure build-up system can compensate for the pressure drop which occurs during the gaseous removal of the hydrogen. To this end, via a corresponding control of the 3/2-way valve, a partial flow via mass flow control of the medium which has been removed through the gas removal line 8 and which has been heated by the first heat exchanger 14 can reach an inner container heat exchanger 17 through a flow line 16. This inner container heat exchanger 4 is arranged to heat the fluid medium in the storage container 3 through which the medium which is supplied downstream from the flow line 16 flows. As a result of the heating on the inner container heat exchanger 17, the fluid medium in the storage container 3 is partially heated and evaporated, which leads to a pressure increase.

Downstream of the inner container heat exchanger 17 and outside the storage container 3 and outside the outer container 4 of the dual-walled container, a second heat exchanger 19 for heating the medium is arranged in a flow line 18.

The flow line 19 opens in an opening in the gas removal line 8 between the 3/2-way valve and the controllable line shut-off valve 12.

In an alternative embodiment shown in FIG. 2, in contrast to FIG. 1 the first line shut-off valve 11 is arranged behind the first heat exchanger 14. The line shut-off valve 11 is, however, arranged downstream in the evacuated hollow space 5 between the inner container 3 and outer container.

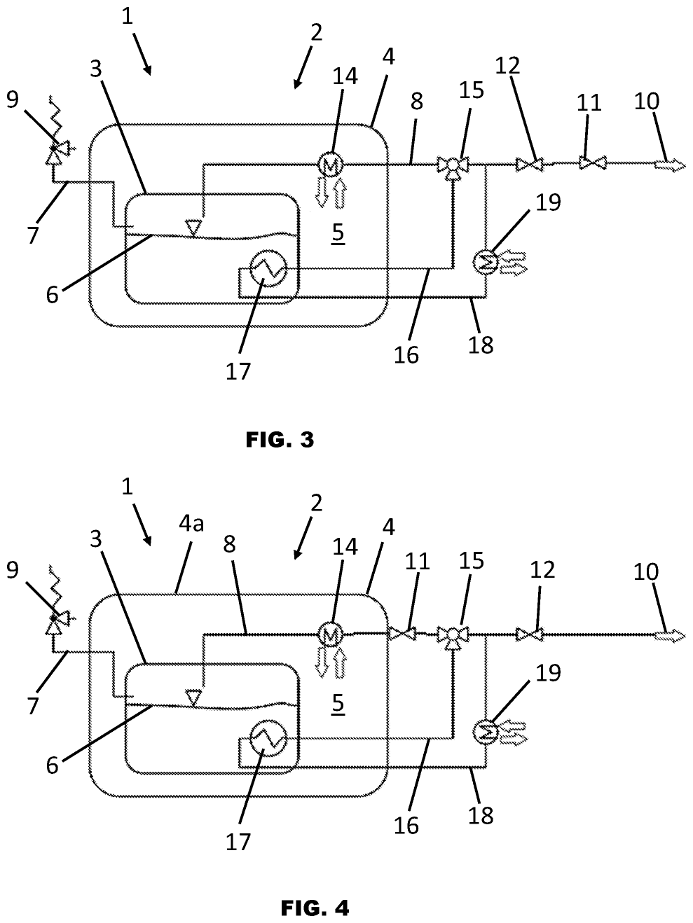

The additional alternative embodiment which is illustrated in FIG. 3 illustrates an arrangement of the first line shut-off valve 11 downstream after the first heat exchanger 14, but outside the evacuated hollow space 5. In this instance, the line shut-off valve 11 is arranged directly in front of the consumer connection 10 in the gas removal line 8.

Alternatively, the line shut-off valve 11 can be arranged downstream after the first heat exchanger 14 directly on the outer side 4a, which delimits the outer container 4 of the container wall, as schematically illustrated in FIG. 4.

In an embodiment which is not illustrated, the line shut-off valve 11 is configured in a fluid removal line. The basic structure of the storage system 1 is otherwise identical, as described in several variants above.

The terms “coupled,” “attached,” or “connected” may be used herein to refer to any type of relationship, direct or indirect, between the components in question, and may apply to electrical, mechanical, fluid, optical, electromagnetic, electromechanical, or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 Storage system
2 Cryogenic tank
3 Storage container/inner container
4 Outer container
4a Outer side of the outer container
5 Hollow space/vacuum chamber
6 Fluid surface
7 Excess pressure relief line
8 Gas removal line
9 Excess pressure safety valve
10 Consumer connection
11 First automatic line shut-off valve
12 Second controllable line shut-off valve
14 First heat exchanger
15 Mass flow control valve
16 Flow line
17 Inner container heat exchanger
18 Flow line
19 Second heat exchanger

What is claimed is:

1. A storage system for storing a cryogenic medium, the storage system comprising:
a dual-wall cryogenic tank that includes an inner storage container and an outer container which surrounds the inner storage container, the inner container defining an inner space which receives the cryogenic medium;
a hollow space defined by the inner storage container and the outer container;
a removal line to serve as a removal duct that forms a fluid-carrying connection from the inner space to a consumer connection;
a first controllable line shut-off valve fluidically connected to the removal line;
a first heat exchanger fluidically connected to the gas removal line;
a pressure build-up system that includes:
a mass flow control valve arranged in the removal line outside of the dual-wall cryogenic tank,
an inner container heat exchanger arranged in the hollow space and fluidically connected to the inner storage container via a first flow line, and
a second heat exchanger which is fluidically connected to the inner storage container via a second flow line,
a controllable line shut-off valve fluidically connected to the removal line and operable to automatically shut off flow of the cryogenic medium in response to a fracture of a fluid-carrying connection.

2. The storage system of claim 1, wherein the removal line comprises a gas removal line.

3. The storage system of claim 1, wherein the controllable line shut-off valve is arranged inside the hollow space downstream of the first heat exchanger.

4. The storage system of claim 1, wherein the controllable line shut-off valve is arranged inside the evacuated hollow space upstream of the first heat exchanger.

5. The storage system of claim 1, wherein the controllable line shut-off valve is arranged outside the hollow space upstream of the controllable line shut-off valve and directly in front of a consumer connection.

6. The storage system of claim 1, wherein the controllable line shut-off valve is arranged outside the evacuated hollow space at an outer side of the outer container.

7. The storage system of claim 1, wherein the storage medium comprises hydrogen.

8. The storage system of claim 1, wherein the mass flow control valve comprises a 3/2-way valve.
